(19) United States
(12) Patent Application Publication
(10) Pub. No.: US 2023/0237443 A1
(43) Pub. Date: Jul. 27, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Aichi-ken (JP)

(72) Inventors: Kenji YAMAGUCHI, Miyoshi-shi (JP); Yusuke KUZUYA, Nagoya-shi (JP); Yoshikazu JIKUHARA, Miyoshi-shi (JP); Kosuke SAKAKIBARA, Toyota-shi (JP); Takashi HAYASHI, Nagoya-shi (JP)

(21) Appl. No.: 17/978,218

(22) Filed: Nov. 1, 2022

(30) Foreign Application Priority Data
Jan. 26, 2022 (JP) 2022-010390

(51) Int. Cl. G06Q 10/00; H04W 4/44; G06Q 30/02

(52) U.S. Cl. CPC G06Q 10/20; H04W 4/44; G06Q 30/0278

(57) ABSTRACT

When users of vehicles provide vehicle-related data that are data related to the vehicles to a manager of a processor, the processor determines available services that are services available for the users based on the vehicle-related data, and transmit information about the available services to notification devices usable by the users.

### CROSS-REFERENCE TO RELATED APPLICATION

This application claims priority to Japanese Patent Application No. 2022-010390 filed on Jan. 26, 2022, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2019-212037 (JP 2019-212037 A) discloses a disclosure for providing economic values to users (drivers) and reducing economic values of the users based on driving operation of vehicles.

### SUMMARY

The disclosure of JP 2019-212037 A has room for improvement in terms of allowing vehicle users to make effective use of vehicle-related data that are data related to vehicles.

In consideration of the above facts, an object of the present disclosure is to provide an information processing device, an information processing method, and a storage medium, capable of allowing users of vehicles to make effective use of vehicle-related data that are data related to the vehicle.

An information processing device according to a first aspect includes a processor. The processor is configured to determine, when a user of a vehicle provides vehicle-related data that is data related to the vehicle to a manager of the processor, available service that is a service available for the user based on the vehicle-related data, and transmit information about the available service to a notification device usable by the user.

The processor of the information processing device according to the first aspect is configured to determine, when a user of a vehicle provides vehicle-related data to a manager of the processor, an available service that is a service available for the user based on the vehicle-related data. The processor is further configured to transmit information about the available service to a notification device usable by the user. Therefore, the user of the vehicle can recognize the service that is available (available service) by providing the vehicle-related data to the manager. Hence, the information processing device according to the first aspect can allow the user of the vehicle to make effective use of the vehicle-related data.

In a second aspect of the information processing device according to the first aspect, the processor may be configured to transmit, to the notification device, information about the vehicle-related data required to be provided to the manager in order for the user to receive the service determined.

In the disclosure according to the second aspect, the processor transmits, to the notification device, information about the vehicle-related data required to be provided to the manager in order for the user to receive the service determined. Therefore, the information processing device in the second aspect can motivate the user to provide the vehicle-related data to the manager.

In a third aspect of the information processing device according to the first or second aspect, the processor may be configured to determine the available service based on a type and an amount of the vehicle-related data.

In the disclosure according to the third aspect, the processor determines the available service based on the type and the amount of the vehicle-related data. Therefore, the information processing device in the third aspect can motivate the user to provide more various vehicle-related data to the manager.

In a fourth aspect of the information processing device according to any one of the first to third aspects, the processor may be configured to determine the available service based on a map defining relationship between the vehicle-related data and the available service and on the vehicle-related data.

In the disclosure according to the fourth aspect, the processor determines the available service based on a map defining relationship between the vehicle-related data and the available service and on the vehicle-related data. Therefore, according to the information processing device in the fourth aspect, the user can exchange the vehicle-related data with the available service.

In a fifth aspect of the information processing device according to any one of the first to fourth aspects, the processor may be configured to determine a value of the vehicle-related data based on the vehicle-related data, and transmit, to the notification device, information about the determined value of the vehicle-related data and information about the service available for the user of the vehicle in accordance with the value.

In the disclosure according to the fifth aspect, the processor determines the value of the vehicle-related data based on the vehicle-related data. The processor further transmits to the notification device the information about the determined value of the vehicle-related data and the information about the service available for the user of the vehicle in accordance with the value. Therefore, according to the information processing device in the fifth aspect, the user can recognize the value of the vehicle-related data and the content of the service that is available.

In a sixth aspect of the information processing device according to any one of the first to fifth aspects, the processor may be configured to provide the vehicle-related data to a provider of the service in response to a request from the provider, and determine the available service such that at least one of an amount and the number of types of the available service determined based on the vehicle-related data is larger as request frequency that is the number of provision requests from the provider is higher.

The disclosure according to the sixth aspect can easily motivate the user to provide the vehicle-related data that is requested at high frequency to the management server.

In a seventh aspect of the information processing device according to any one of the first to sixth aspects, the processor may be configured to determine the available service such that at least one of an amount and the number of types of the available service determined based on the vehicle-related data is larger as freshness of the vehicle-related data is higher.

The disclosure according to the seventh aspect can easily motivate the user to provide the vehicle-related data that is high in freshness to the management server.

An information processing method according to an eighth aspect is executed by a processor. The method includes: determining, when a user of a vehicle provides vehicle-related data that is data related to the vehicle to a manager of the processor, available service that is a service available for the user based on the vehicle-related data; and transmitting information about the available service to a notification device usable by the user.

A storage medium storing a program according to the disclosure in a ninth aspect causes a processor to execute a process. The process includes: determining, when a user of a vehicle provides vehicle-related data that is data related to the vehicle to a manager of the processor, available service that is a service available for the user based on the vehicle-related data, and transmitting information about the available service to a notification device usable by the user.

As described above, the information processing device, the information processing method, and the storage medium according to the present disclosure have an excellent effect of being able to allow a user of a vehicle to make effective use of vehicle-related data that is data related to the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an overall configuration of a vehicle-related data distribution system including an information processing device according to an embodiment;

FIG. 2 is a control block diagram of a management server, each of operation terminals, and each of vehicles shown in FIG. 1;

FIG. 3 is a functional block diagram of the management server;

FIG. 4 shows a map recorded on the management server;

FIG. 5 is a functional block diagram of each of the operation terminals;

FIG. 6 is a functional block diagram of an ECU of the vehicles;

FIG. 7 is a functional block diagram of the operation terminals;

FIG. 8 is a flowchart showing a process executed by each of the operation terminals;

FIG. 9 is a flowchart showing a process executed by the management server;

FIG. 10 is a flowchart showing a process executed by each of the operation terminals;

FIG. 11 is a flowchart showing a process executed by the management server;

FIG. 12 is a flowchart showing a process executed by each of mobile terminals;

FIG. 13 shows a display of the mobile terminals:

FIG. 14 is a flowchart showing a process executed by a vehicle ECU; and

FIG. 15 is a flowchart showing a process executed by each of the mobile terminals.

### DETAILED DESCRIPTION OF EMBODIMENTS

Hereinafter, an embodiment of the information processing device, an information processing method, and a storage medium according to the present disclosure will be described with reference to the drawings.

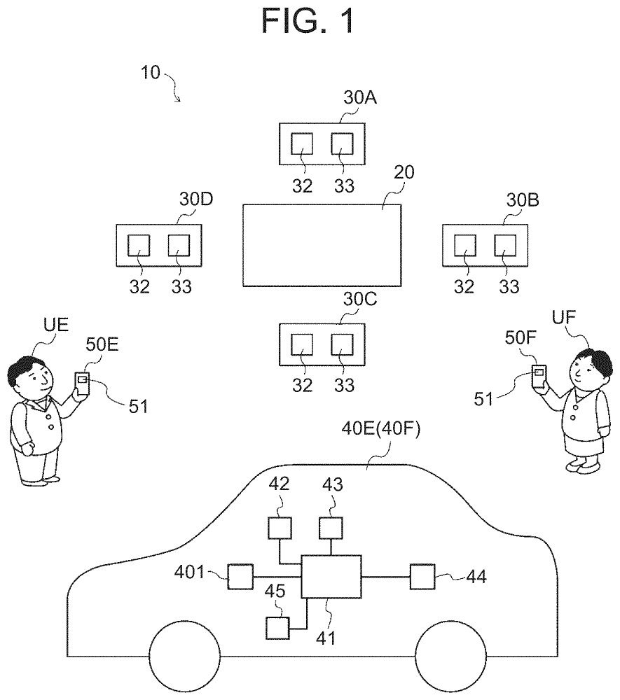

As shown in FIG. 1, a management server (information processing device) 20, a first operation terminal 30A, a second operation terminal 30B, a third operation terminal 30C, a fourth operation terminal 30D, vehicles 40E, 40F, and mobile terminals (notification devices) 50E, 50F in the present embodiment are component members of a vehicle-related data distribution system 10. Hereinafter, the vehicle-related data distribution system 10 will be simply referred to as the system 10. The management server 20, the first operation terminal 30A, the second operation terminal 30B, the third operation terminal 30C, the fourth operation terminal 30D, the vehicles 40E, 40F, and the mobile terminals 50E, 50F will be described below.

The management server 20 is placed in a building (not shown) owned by a manager. The first operation terminal 30A is placed in a building (not shown) of a vehicle maintenance factory A. The second operation terminal 30B is placed in a building (not shown) of a vehicle maintenance factory B. The third operation terminal 30C is placed in a building (not shown) of a used car sales company C. The fourth operation terminal 30D is placed in a building (not shown) of a used car sales company D. The vehicle 40E and the mobile terminal 50E are owned by a user UE. The vehicle 40F and the mobile terminal 50F are owned by a user UF. The vehicle maintenance factory A, the vehicle maintenance factory B, the used car sales company C, the used car sales company D, and the user UE are members of the system 10 managed by the manager. Furthermore, the vehicle maintenance factory A, the vehicle maintenance factory B, the used car sales company C, and the used car sales company D are specified members. The user UE, who is a member, has already notified the manager and other members of his or her personal information and information about a vehicle identification number (yin) code of the vehicle 40E. The user UF, on the other hand, is not a member of the system 10.

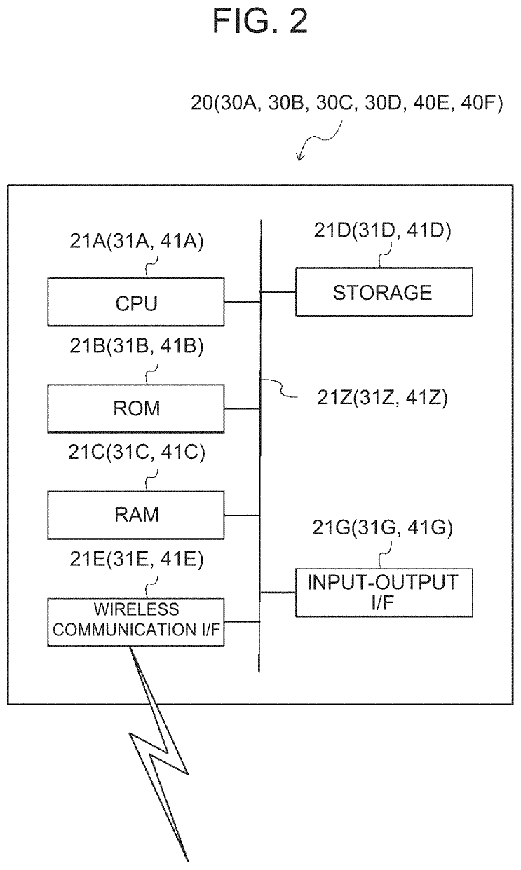

As shown in FIG. 2, the management server 20 has a hardware configuration including a central processing unit (CPU) (processor) 21A, a read only memory (ROM) 21B, a random access memory (RAM) 21C, a storage 21D, a wireless communication interface (IF) 21E, and an input-output IF 21G. The CPU 21A, the ROM 21B, the RAM 21C, the storage 21D, the wireless communication IF 21E, and the input-output IF 21G are communicably connected with each other through an inside bus 21Z. The CPU 21A and each of CPUs described later can acquire information about time from a timer.

The CPU 21A is a central processing unit that executes various programs, and controls each unit. The CPU 21A reads programs from the ROM 21B or the storage 21D, and executes the programs by using the RAM 21C as a work area. The CPU 21A controls each component member and performs various calculation processes according to the programs recorded on the ROM 21B or the storage 21D. The ROM 21B or the storage 21D is an example of a storage medium.

The ROM 21B stores various programs and various data. For example, the ROM 21B has a plurality of programs installed therein. For example, the ROM 21B has a vehicle identification list recorded thereon. The vehicle identification list includes personal information about users who are members and information about the vehicle identification number (yin) code of each of the vehicles owned by the members. The personal information on the users includes information about whether the users are members of the system 10. The RAM 21C functions as a work area to temporarily store programs or data. The storage 21D is constituted of a storage device, such as a hard disk drive (HDD) or a solid state drive (SSD), to store various programs and various data. For example, on the storage 21D, a map 25 described later is recorded.

The wireless communication IF 21E is an interface for wireless communication with various devices. For example, the wireless communication IF 21E can perform wireless communication with the first operation terminal 30A, the second operation terminal 30B, and the third operation terminal 30C, the fourth operation terminal 30D, the vehicles 40E, 40F, and the mobile terminals 50E, 50F through a network (e.g., the Internet).

The input-output IF 21G is an interface for communication with various devices.

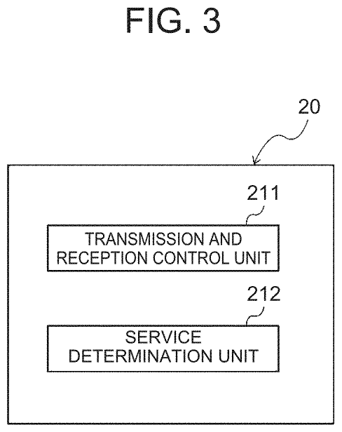

FIG. 3 shows an example of the functional configuration of the management server 20 in the form of a block diagram. The management server 20 has a transmission and reception control unit 211 and a service determination unit 212 as the functional configuration. The transmission and reception control unit 211 and the service determination unit 212 are implemented when the CPU 21A reads and executes programs stored in the ROM 21B.

The transmission and reception control unit 211 controls the wireless communication IF 21E. The wireless communication IF 21E controlled by the transmission and reception control unit 211 can record the data received from the outside on the ROM 21B and the storage 21D, and wirelessly transmit the data recorded on the ROM 21B and the storage 21D to the outside.

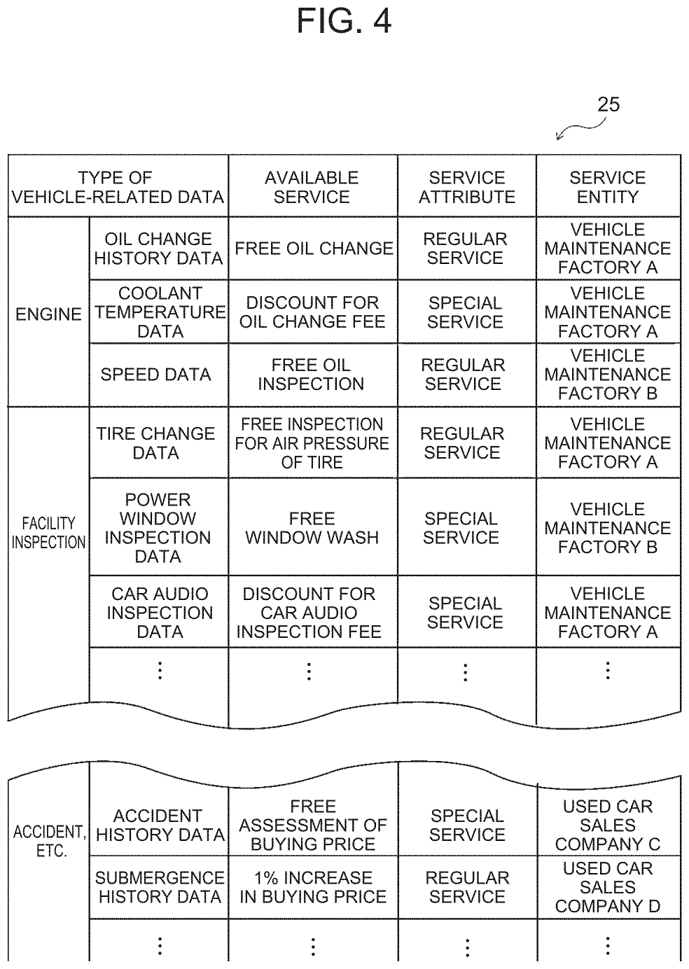

The service determination unit 212 identifies the types of vehicle-related data that are received from the first operation terminal 30A, the second operation terminal 30B, the third operation terminal 30C, the fourth operation terminal 30D, the vehicles 40E, 40F or the mobile terminals 50E, 50F and recorded on the storage 21D, based on the map 25 (see FIG. 4) stored in the ROM 21B or the storage 21D.

The map 25 defines the relationship between a plurality of types of vehicle-related data and a plurality of types of services. In other words, the map 25 defines the vehicle-related data required to be provided to the management server 20 (system 10) in order for the users UE, UF to receive services determined. These services can be provided by the specified members to the users UE, UF. The types of providable services are different for each specified member. The types of available services for the user UE who is a member and the user UF who is not a member are also different. Here, the services available for only the users who are members are referred to as special services, and the services available for all the users are referred to as regular services.

The service determination unit 212 further determines, based on the map 25, services that can be exchanged with the vehicle-related data transmitted to the management server 20.

As shown in FIG. 2, the first operation terminal 30A, the second operation terminal 30B, the third operation terminal 30C, and the fourth operation terminal 30D have the same hardware configuration as the management server 20. In other words, the first operation terminal 30A, the second operation terminal 30B, the third operation terminal 30C, and the fourth operation terminal 30D have the following hardware configurations: a CPU 31A, a ROM 31B, a RAM 31C, a storage 31D, a wireless communication IF 31E, an input-output IF 31G and an internal bus 31Z. For example, the ROM 31B has a plurality of programs installed therein. In addition, the vehicle identification list is recorded on the ROM 31B in each of the first operation terminal 30A, the second operation terminal 30B, the third operation terminal 30C, and the fourth operation terminal 30D. In addition, the first operation terminal 30A, the second operation terminal 30B, the third operation terminal 30C, and the fourth operation terminal 30D each include an input device 32 and a display 33 connected to the input-output IF 31G. The input device 32 is a touchpanel, for example.

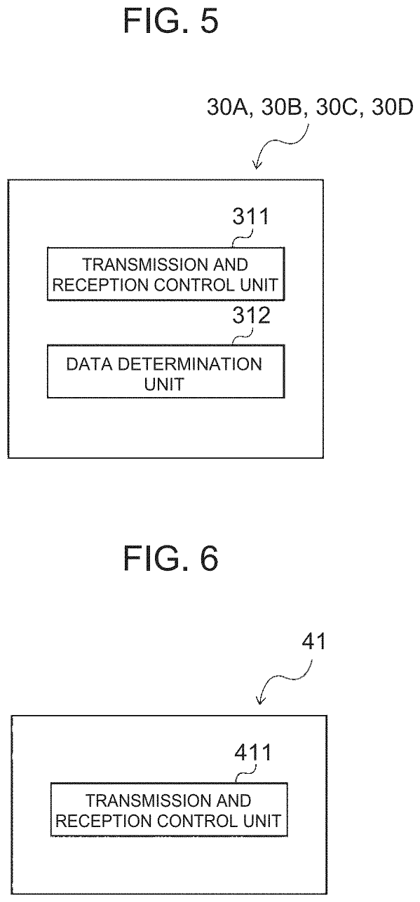

In FIG. 5, an example of the functional configuration of the first operation terminal 30A, the second operation terminal 30B, the third operation terminal 30C, and the fourth operation terminal 30D are shown in the form of a block diagram. The first operation terminal 30A, the second operation terminal 30B, the third operation terminal 30C, and the fourth operation terminal 30D each include a transmission and reception control unit 311 and a data determination unit 312 as the functional configuration.

The transmission and reception control unit 311 in each of the first operation terminal 30A, the second operation terminal 30B, the third operation terminal 30C, and the fourth operation terminal 30D controls the wireless communication IF 31E. The wireless communication IFs 31E controlled by the transmission and reception control units 311 can each record the vehicle-related data received from the outside on the ROM 31B or the storage 31D, and wirelessly transmit the vehicle-related data recorded on the ROM 31B or the storage 31D to the outside.

The data determination unit 312 determines whether the vehicle-related data received from the outside is new vehicle-related data which is different from the vehicle-related data already recorded on the ROM 31B or the storage 31D. The data determination unit 312 further determines whether the vehicle-related data received from the outside is the data transmitted from a member. Specifically, the data determination unit 312 determines whether the received vehicle-related data is vehicle-related data on the vehicle of a user who is a member, based on the ID information attached to each of the vehicle-related data.

As shown in FIG. 1, the vehicles 40E, 40F each include an electronic control unit (ECU) 41. As shown in FIG. 2, the ECU 41 includes a CPU (processor) 41A, a ROM 41B, a RAM 41C, a storage 41D, a wireless communication IF 41E, an input-output IF 41G and an internal bus 41Z. For example, the ROM 41B has a plurality of programs installed therein. The input-output IF 41G is connected to an ignition switch (IG-SW) 401. When the IG-SW 401 is in an OFF state, a driving source of each of the vehicles 40E, 40F is disabled. When the IG-SW 401 is in an ON state, the driving source is enabled. For example, the driving source includes at least one of an engine and an electric motor. Therefore, the “IG-SW” in this specification includes an ignition switch operated by a key and other switches. The other switches include, for example, a push start button.

The ECU 41 can communicate with a driving source ECU 42, a brake ECU 43, a camera ECU 44 and a steering ECU 45 shown in FIG. 1. In addition, the driving source ECU 42 is connected to the driving source (not shown). The brake ECU 43 is connected to a brake device (brake actuator) and wheel speed sensors (which are not shown). The camera ECU 44 is connected to cameras (snot shown). The steering ECU 45 is connected to a steering angle sensor, a steering torque sensor, and a steering motor (which are not shown). Accordingly, the driving source ECU 42 can acquire various vehicle-related data from the driving source. The brake ECU 43 can acquire various vehicle-related data from the brake device and the wheel speed sensors. The camera ECU 44 can acquire various vehicle-related data from the cameras. The steering ECU 45 can acquire various vehicle-related data from the steering angle sensor, the steering torque sensor, and the steering motor. The vehicle-related data acquired by the driving source ECU 42, the brake ECU 43, the camera ECU 44 and the steering ECU 45 are transmitted to the ECU 41 and recorded on the ROM 41B or the storage 41D.

FIG. 6 shows an example of the functional configuration of the ECU 41 in the form of a block diagram. The ECU 41 includes a transmission and reception control unit 411 as the functional configuration.

The wireless communication IF 41E controlled by the transmission and reception control unit 411 can wirelessly communicate with the management server 20, the first operation terminal 30A, the second operation terminal 30B, the third operation terminal 30C, the fourth operation terminal 30D, and the mobile terminals 50E, 50F via the network. The wireless communication IF 41E can record the data received from the outside on the ROM 41B and the storage 41D, and wirelessly transmit the data recorded on the ROM 41B and the storage 41D to the outside.

The mobile terminals 50E, 50F shown in FIG. 1 have configuration including a CPU, a ROM, a RAM, a storage, a communication IF and an input-output IF. Examples of the mobile terminals 50E, 50F include a smartphone or a tablet computer. The CPU, the ROM, the RAM, the storage, the wireless communication IF, and the input-output IF in the mobile terminals 50E, 50F are communicably connected with each other through a bus. The mobile terminals 50E, 50F are each provided with a display 51 having a touch panel. The display 51 is connected to the input-output IF of each of the mobile terminals 50E, 50F. In addition, on the ROM of each of the mobile terminals 50E, 50F, an application (program) for joining the system is installed.

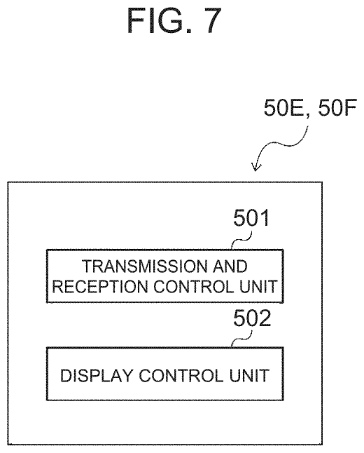

FIG. 7 shows an example of the functional configuration of the mobile terminals 50E, 50F in the form of a block diagram. The mobile terminals 50E, 50F each include a transmission and reception control unit 501 and a display control unit 502 as the functional configuration. The transmission and reception control unit 501 and the display control unit 502 are implemented when the CPU reads and executes programs stored in the ROM.

The wireless communication IF controlled by the transmission and reception control unit 501 can wirelessly communicate with the management server 20, the first operation terminal 30A, the second operation terminal 30B, the third operation terminal 30C, the fourth operation terminal 30D, and the vehicles 40E, 40F.

The display control unit 502 controls the display 51. Specifically, the display control unit 502 displays on the display 51 the information received by the wireless communication IF and the information input via the touch panel, for example. The information input through the touch panel of the display 51 can be transmitted to the outside by the wireless communication IF.

Functions and Effects

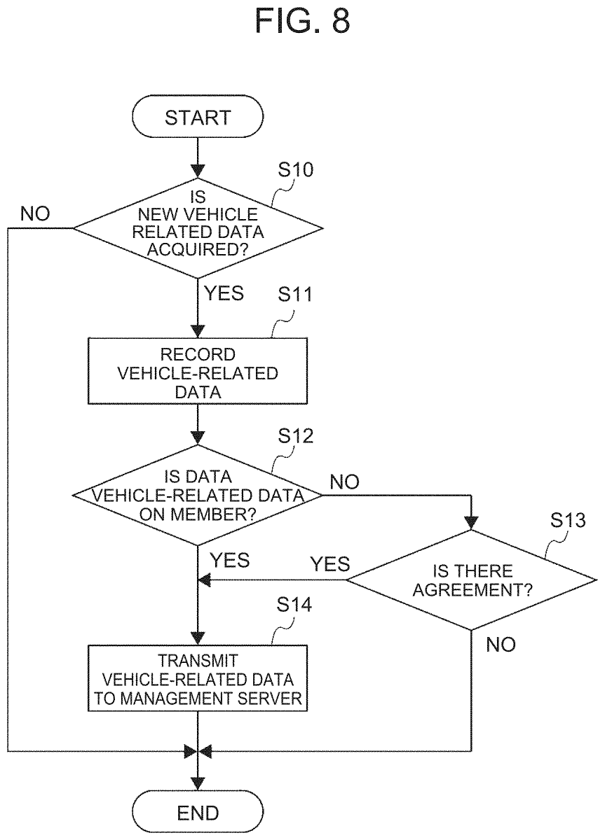

Description is now given of the functions and effects of the present embodiment with reference to flowcharts in FIGS. 8 to 15.

The CPU 31A in each of the first operation terminal 30A, the second operation terminal 30B, the third operation terminal 30C, and the fourth operation terminal 30D repeatedly execute the process of the flowchart in FIG. 8 whenever a prescribed time elapses.

First, in step S10, the CPU 31A determines whether new vehicle-related data not recorded on the ROM 31B and the storage 31D are acquired from the first operation terminal 30A, the second operation terminal 30B, the third operation terminal 30C, the fourth operation terminal 30D, the vehicles 40E, 40F, the mobile terminal 50E, or the mobile terminal 50F. The vehicle-related data in this case includes, for example, data about maintenance inspection of the vehicle 40E which has received maintenance and inspection in the vehicle maintenance factory A, the data being input into the first operation terminal 30A via the input device 32. The vehicle-related data in this case also includes, for example, data about an accident history of the vehicle 40E wirelessly transmitted from the mobile terminal 50E to the second operation terminal 30B.

When determining Yes in step S10, the CPU 31A proceeds to step S11 to record the received vehicle-related data on the ROM 31B or the storage 31D.

After ending the process of step S11, the CPU 31A proceeds to step S12 to determine whether the vehicle-related data recorded in step S11 is vehicle-related data on the vehicle of a user who is a member, based on the ID information attached to each of the vehicle-related data. Note that a user who is a member has a contract with the manager to agree that the vehicle-related data on all the vehicles possessed by the user shall be transmitted to other members and the manager (management server 20) and shall be recorded on the recording devices owned by other members and the manager. The contract further stipulates that when the user who is a member acquires the vehicle-related data that the vehicle of the member is not entitled to acquire automatically, the user shall notify the manager of the vehicle-related data using a mobile device or the like. Such vehicle-related data includes, for example, a vehicle accident history, a vehicle submergence history, and a history of vehicle maintenance performed in non-member vehicle maintenance factories.

When determining No in step S12, the CPU 31A proceeds to step S13 to determine whether the user UF (the vehicle 40F, the mobile terminal 50F) who is not a member agrees with the vehicle-related data acquired from the user UF being transmitted to members and the manager (management server 20). For example, when the user UF has a contract with the manager to agree with all the vehicle-related data of the vehicle 40F being transmitted to members and the manager (management server 20), and the content of the contract is recorded on the ROM 31B or the storage 31D, the CPU 31A determines Yes in step S13.

When determining Yes in step S12 or S13, the CPU 31A proceeds to step S14 to wirelessly transmit the vehicle-related data recorded in step S11 to the management server 20.

When ending the process of step S14 or when determining No in steps S10 and S13, the CPU 31A temporarily ends the process of the flowchart in FIG. 8.

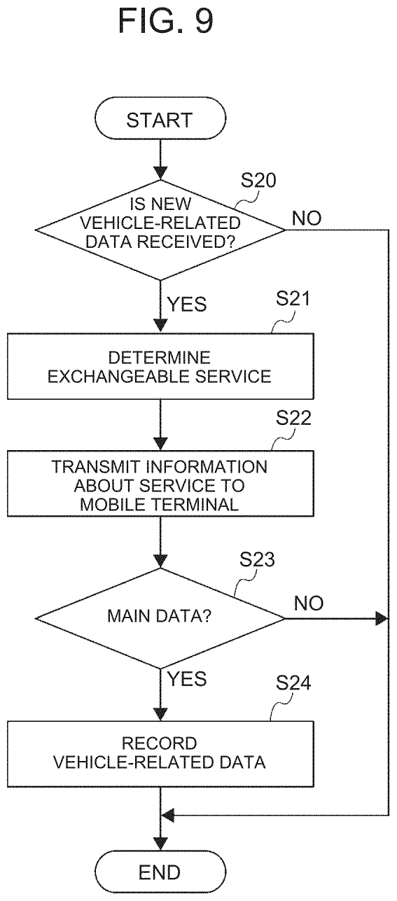

The CPU 21A of the management server 20 repeatedly executes the process of the flowchart in FIG. 9 whenever a prescribed time elapses.

First, in step S20, the CPU 21A determines whether the wireless communication IF 21E receives new vehicle-related data not yet recorded on the ROM 21B and the storage 21D of the management server 20 from at least one of the first operation terminal 30A, the second operation terminal 30B, the third operation terminal 30C, the fourth operation terminal 30D, the vehicles 40E, 40F, and the mobile terminals 50E, 50F.

When determining Yes in step S20, the CPU 21A proceeds to step S21 to determine the service exchangeable with the vehicle-related data determined Yes in step S20 based on the received vehicle-related data and the map 25 recorded on the storage 21D.

After ending the process in step S21, the CPU 21A proceeds to step S22 to control the wireless communication IF 21E so as to wirelessly transmit information about the service determined in step S21 to the mobile terminal 50E or the mobile terminal 50F. When the vehicle-related data subjected to determination in step S20 is the data on the vehicle 40E, then the information about the service determined in step S21 is transmitted to the mobile terminal 50E in step S22. When the vehicle-related data subjected to determination in step S20 is the data on the vehicle 40F, then the information about the service determined in step S21 is transmitted to the mobile terminal 50F in step S22.

After ending the process in step S22, the CPU 21A proceeds to step S23 to determine whether the vehicle-related data subjected to determination in step S21 is main data or test data. Here, the test data is vehicle-related data transmitted by the users UE, UF, to the management server 20 for the purpose of knowing the contents of the exchangeable service as described later. In other words, when the users UE, UF transmit test data to the management server 20, the users UE, UF are unable to receive the service. On the other hand, the main data is vehicle-related data other than the test data. When the main data is transmitted to the management server 20, the users UE, UF are able to know the contents of the exchangeable service and receive the service.

When determining Yes in step S23, the CPU 21A proceeds to step S24 to record the vehicle-related data that is main data on the ROM 21B or the storage 21D.

When ending the process in step S24 or when determining No in steps S20 and S23, the management server 20 temporarily ends the process of the flowchart in FIG. 9.

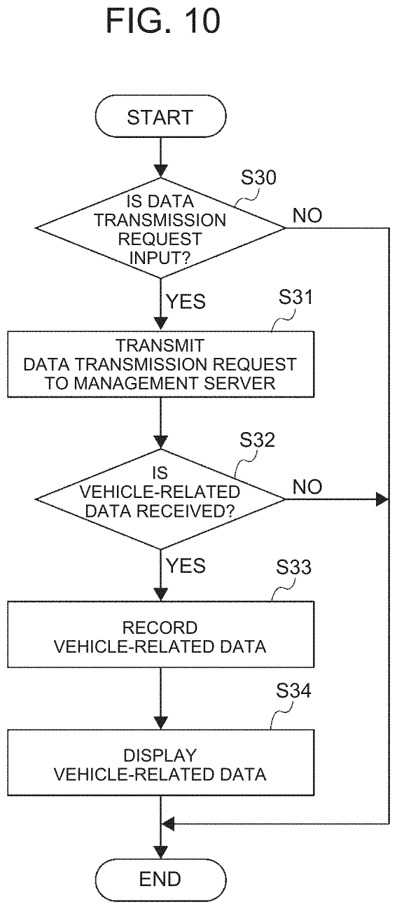

The CPU 31A in each of the first operation terminal 30A, the second operation terminal 30B, the third operation terminal 30C, and the fourth operation terminal 30D repeatedly executes the process of the flowchart in FIG. 10 whenever a prescribed time elapses.

First, in step S30, the CPU 31A determines whether a data transmission request is input using the input device 32 in each of the first operation terminal 30A, the second operation terminal 30B, the third operation terminal 30C, and the fourth operation terminal 30D. The data transmission request includes information that identifies the vehicle and the vehicle-related data.

When determining Yes in step S30, the CPU 31A proceeds to step S31 to control the wireless communication IF 31E so as to wirelessly transmit the data transmission request to the management server 20.

After ending the process in step S31, the CPU 31A proceeds to step S32 to determine whether vehicle-related data is received from the management server 20.

When determining Yes in step S32, the CPU 31A proceeds to step S33 to record the vehicle-related data received from the management server 20 on the ROM 31B or the storage 31D.

After ending the process in step S33, the CPU 31A proceeds to step S34 to display all the vehicle-related data recorded on the ROM 31B or the storage 31D in step S33, on the display 33. Here, assume the case where an operator of the vehicle maintenance factory A transmits a data transmission request together with information identifying the vehicle 40E and the vehicle-related data to the management server 20 using the input device 32 in step S30. In this case, the operator can know various vehicle-related data on the vehicle 40E by viewing the display 33 of the first operation terminal 30A. For example, when the vehicle-related data includes information indicating that the vehicle 40E was involved in a crash accident in the past, then the operator can take this fact into account when performing repair and maintenance of the vehicle 40E.

When ending the process in step S34 or when determining No in steps S30 and S31, the CPU 31A in the first operation terminal 30A, the second operation terminal 30B, the third operation terminal 30C, and the fourth operation terminal 30D temporarily ends the process of the flowchart in FIG. 10.

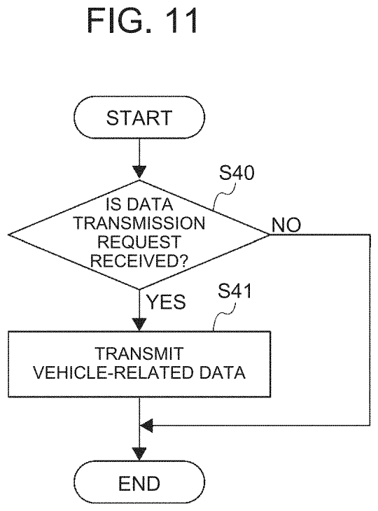

The CPU 21A of the management server 20 repeatedly executes the process of the flowchart in FIG. 11 whenever a prescribed time elapses.

First, in step S40, the CPU 21A determines whether a data transmission request is received from the first operation terminal 30A, the second operation terminal 30B, the third operation terminal 30C, and the fourth operation terminal 30D.

When determining Yes in step S40, the CPU 21A proceeds to step S41 to control the wireless communication IF 21E so as to wirelessly transmit, to the first operation terminal 30A, the second operation terminal 30B, the third operation terminal 30C, and the fourth operation terminal 30D that have transmitted the data transmission request, the requested vehicle-related data on the pertinent vehicle.

When ending the process in step S41 or when determining No in step S40, the CPU 21A of the management server 20 temporarily ends the process of the flowchart in FIG. 11.

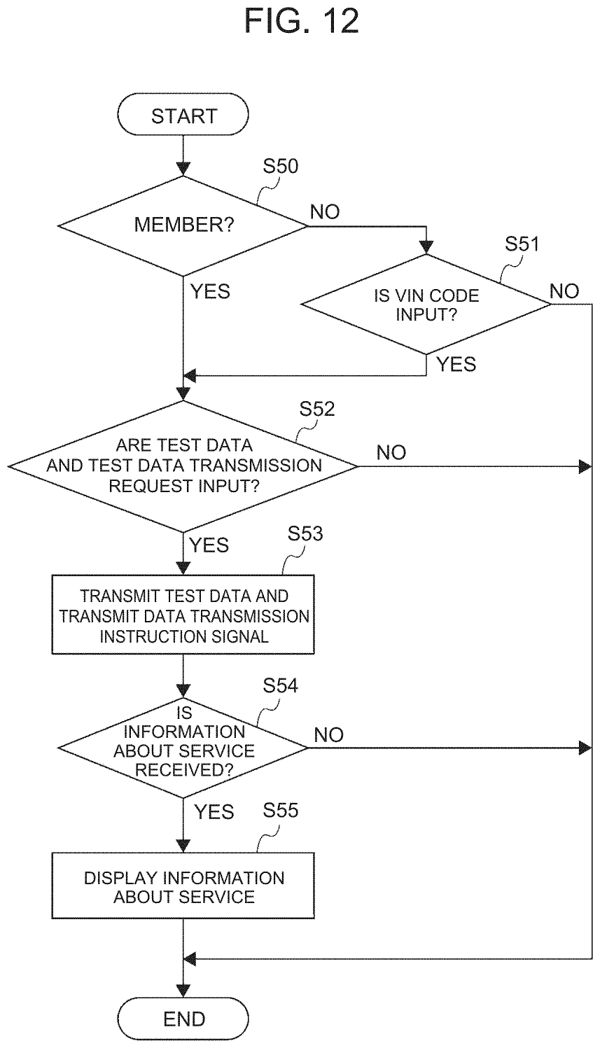

The CPU in each of the mobile terminals 50E, 50F repeatedly executes the process of the flowchart in FIG. 12 whenever a prescribed time elapses. Note that the application (program) for joining the system is in an activated state.

First, in step S50, the CPU uses the display 51 to determine whether the ID and the password assigned to each member of the system 10 are input. In other words, the CPU determines whether a member is performing an input operation.

When determining No in step S50, the CPU proceeds to step S51. Specifically, when determining that the user who has performed the input operation is not a member, the CPU uses the display 51 to determine whether the yin code is input.

When determining Yes in step S50 or S51, the CPU proceeds to step S52 to determine whether the vehicle-related data that is test data and a test data transmission request are input using the display 51.

When determining Yes in step S52, the CPU proceeds to step S53 to control the wireless communication IF so as to wirelessly transmit the test data to the management server 20. For example, when the user UE who is a member performs the input process in step S50, the wireless communication IF of the mobile terminal 50E wirelessly transmits, as test data, the vehicle-related data input into the mobile terminal 50E through the display 51 to the management server 20. The vehicle-related data (test data) includes, for example, an accident history of the vehicle 40E, and a history of maintenance performed in non-member vehicle maintenance factories. When the user UF who is not a member performs an input process of the yin code of the vehicle 40F in step S51, the wireless communication IF of the mobile terminal 50F wirelessly transmits, as test data, the vehicle-related data input into the mobile terminal 50F through the display 51 to the management server 20. The vehicle-related data includes, for example, information on a submergence history of the vehicle 40F. Further in step S53, the mobile terminal 50E transmits a data transmission instruction signal to the vehicle 40E, and the mobile terminal 50F transmits a data transmission instruction signal to the vehicle 40F. As described later, upon reception of the data transmission instruction signals, the wireless communication IFs 41E of the vehicles 40E, 40F wirelessly transmit the vehicle-related data on the vehicles 40E, 40F to the management server 20 as test data.

After ending the process in step S53, the CPU proceeds to step S54 to determine whether the wireless communication IFs receive, from the management server 20, information about the services exchangeable with the test data transmitted to the management server 20.

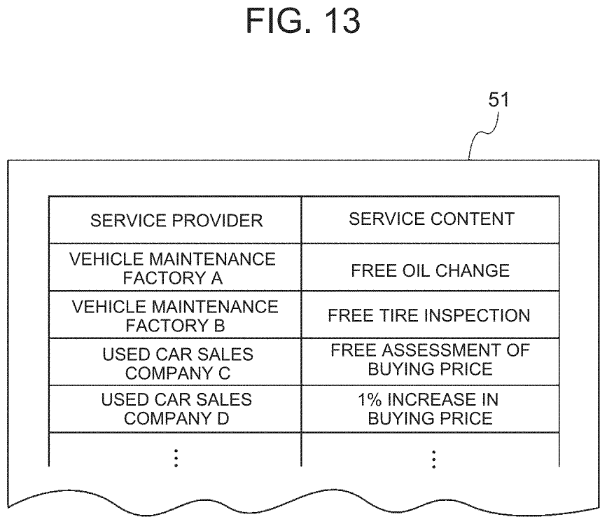

When determining Yes in step S54, the CPU proceeds to step S55 to display on the display 51 the information about the services received from the management server 20, as shown in FIG. 13. Hence, for example, the users UE, UF, who view the displays 51 of the mobile terminals 50E, 50F, are able to know what services are available from the system 10 in the case of providing the vehicle-related data on the vehicles 40E, 40E to the management server 20. The service that the users UE, UF can receive when providing the vehicle-related data to the management server 20 are referred to as available services.

When ending the process in step S55 or when determining No in steps S51, S52, S54, the CPUs of the mobile terminals 50E, 50F temporarily end the process of the flowchart in FIG. 12.

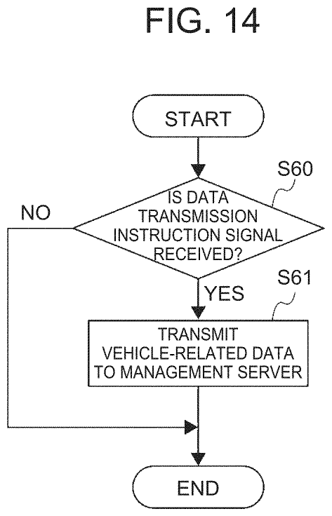

The CPU 41A of the ECU 41 in each of the vehicles 40E, 40F with the IG-SW 401 in the ON state repeatedly executes the process of the flowchart in FIG. 14 whenever a prescribed time elapses.

First, in step S60, the CPUs 41A of the ECUs 41 determine whether data transmission instruction signals from the mobile terminals 50E, 50F are received.

When determining Yes in step S60, the CPUs 41A proceed to step S61 to control the wireless communication IFs 41E so as to wirelessly transmit the requested vehicle-related data to the management server 20.

When ending the process in step S61 or when determining No in step S40, the CPUs 41A of the ECUs 41 temporarily end the process of the flowchart in FIG. 14.

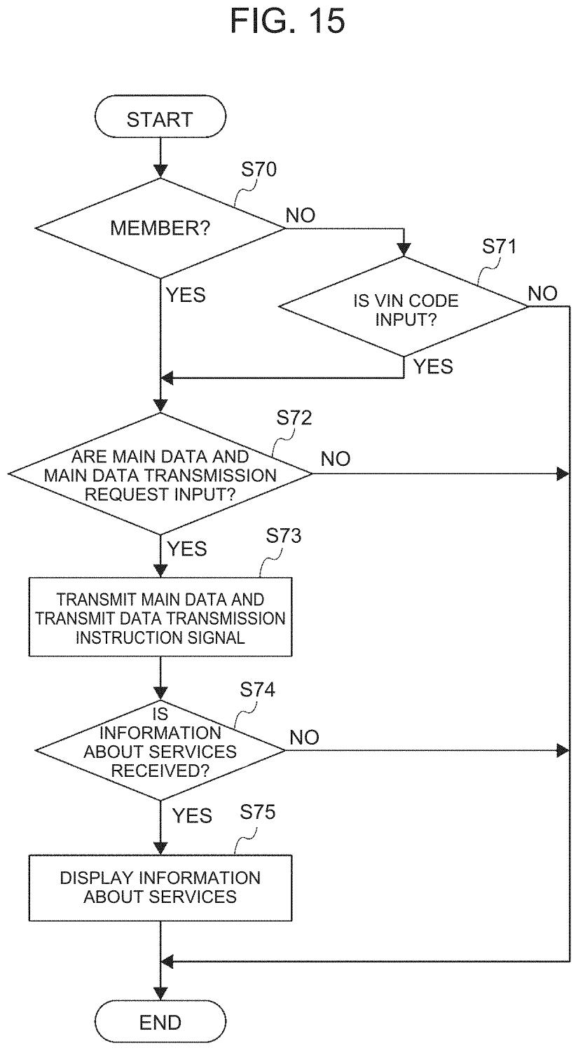

The CPU of each of the mobile terminals 50E, 50F repeatedly executes the process of the flowchart in FIG. 15 whenever a prescribed time elapses. Note that the application for joining the system is in an activated state.

The CPU performs the process in step S70, and when determining No in step S70, the CPU performs the process in step S71. The processes in steps S70 and S71 are identical to the processes in steps S50 and S51 in FIG. 12, respectively.

When determining Yes in step S70 or S71, the CPU proceeds to step S72 to determine whether the vehicle-related data that is main data and a main data transmission request are input using the display 51.

When determining Yes in step S72, the CPU proceeds to step S73. The content of the process in step S73 is substantially identical to the content of the process in step S53. Specifically, the wireless communication IF is controlled so as to wirelessly transmit the main data to the management server 20. Furthermore, the mobile terminal 50E transmits a data transmission instruction signal to the vehicle 40E, and the mobile terminal 50F transmits a data transmission instruction signal to the vehicle 40F.

After ending the process in step S73, the CPU proceeds to step S74 to determine whether the wireless communication IF receives information about the services exchangeable with the main data transmitted to the management server 20 from the management server 20.

When determining Yes in step S74, the CPU proceeds to step S75 to display on the display 51 information about the services received from the management server 20, as shown in FIG. 13.

When ending the process in step S75 or when determining No in steps S71, S72, S74, the CPU in each of the mobile terminals 50E, 50F temporarily ends the process of the flowchart in FIG. 15.

As described in the foregoing, in the present embodiment, the CPU 21A of the management server 20 determines the available services that are services available for the users UE, UF when the vehicle-related data are provided to the management server 20, based on the type and the amount of the vehicle-related data provided to the management server 20. The information about the available services is further transmitted to the mobile terminals 50E, 50F of the users UE, UF. Therefore, the users UE, UF can recognize the services available (available services) by providing the vehicle-related data to the management server 20. This allows the users UE, UF to make effective use of the vehicle-related data.

Moreover, the system 10 can motivate the users UE, UF who have recognized the available services to provide the vehicle-related data to the management server 20.

Although the information processing device, the information processing method and the storage medium according to the embodiment have been described in the foregoing, designs of the information processing device, the information processing method and the storage medium can be changed as appropriate without departing from the spirit of the present disclosure.

For example, the management server 20 may determine the value of the vehicle-related data provided to the management server 20, and notify the determined value to the mobile terminals 50E, 50F. The value may be, for example, money (price), or may be points issued by the management server 20. The management server 20 may further determine the amount of money and points based on the type and the amount of the vehicle-related data to be provided. The user can exchange the money or points with services provided by the members (the first operation terminal 30A, the second operation terminal 30B, the third operation terminal 30C, and the fourth operation terminal 30D).

The system 10 may be configured such that whenever transmission and reception of vehicle-related data is performed among the management server 20, the first operation terminal 30A, the second operation terminal 30B, the third operation terminal 30C, the fourth operation terminal 30D, and the vehicles 40E, 40F, the system 10 may request a user to agree with transmission and reception of the vehicle-related data as a transmission and reception target, and the vehicle-related data is transmitted and received when the user agrees with the transmission and reception. For example, the system 10 may transmit a message for requesting an agreement to the mobile terminal of a user who is a member, and the user may transmit a message of agreement from his or her mobile terminal to the management server 20 to indicate his or her intention to agree with the transmission and reception of the vehicle-related data.

When the type and the amount of the vehicle-related data to be provided are the same, the service, money or points provided to the users may be varied in accordance with how the users agree with the transmission and reception of the vehicle-related data. For example, when a user makes a contract to agree with provision of all the vehicle-related data at the time of registering in the system 10 as a member, the user may receive more services, money or points than the case where the system 10 requests an agreement of the user whenever the vehicle-related data is transmitted or received.

Two or more entities included in the management server 20, the first operation terminal 30A, the second operation terminal 30B, the third operation terminal 30C, the fourth operation terminal 30D, the vehicle 40E, and the mobile terminal 50E, can transmit and receive each data to and from each other via a wired network.

The map 25 may be prepared to allow a user to receive a plurality of available services when the user provides a single piece of vehicle-related data to the management server 20. It is also possible to allow a user to receive a single available service a plurality of times when the user provides a single piece of vehicle-related data to the management server 20. The map 25 may also be prepared to allow a user to receive a single available service when the user provides a plurality of pieces of vehicle-related data to the management server 20. The map 25 may also be prepared such that an available service is determined based on the amount (number) of the vehicle-related data to be provided, regardless of the type of the vehicle-related data provided by the user to the management server 20.

The map 25 may also be prepared such that at least one of the amount (number) and the number of types of available services, available based on the vehicle-related data that receives more requests for data transmission from members (the first operation terminal 30A, the second operation terminal 30B, the third operation terminal 30C, the fourth operation terminal 30D), is made larger than that of available services available based on the vehicle-related data that receives less requests for data transmission. In other words, as the request frequency that is the number of data transmission requests (provision requests) for vehicle-related data is higher, at least one of the amount and the number of types of the available services may be made larger. For example, when the request frequency of “oil change history data” shown in FIG. 4 is higher than the request frequency of “power window inspection data”, the amount and the number of types of available services available based on the oil change history data may be made larger than the amount and the number of types of available services available based on the power window inspection data. According to this modified example, the user is easily motivated to provide the more frequently requested vehicle-related data to the management server 20.

The map 25 may also be prepared such that at least one of the amount and the number of types of the available services determined based on the vehicle-related data is made larger as freshness of the vehicle-related data provided to the management server 20 is higher. For example, at least one of the amount and the number of types of available service available based on the accident history data a month ago may be made larger than that of the available services available based on the accident history data a year ago. According to this modified example, the user is easily motivated to provide more fresh vehicle-related data to the management server 20.

Based on the request frequency of the vehicle-related data and the freshness of the vehicle-related data, at least one of the amount and the type of services available for the user may be determined.

The system 10 may be constructed using a block chain. The type of the block chain in this case is not limited. For example, the block chain in this case may be a consortium-type block chain in which the first operation terminal 30A, the second operation terminal 30B, the third operation terminal 30C, and the fourth operation terminal 30D constitute nodes.

What is claimed is:

1. An information processing device, comprising a processor, the processor being configured to determine, when a user of a vehicle provides vehicle-related data that is data related to the vehicle to a manager of the processor, an available service that is a service available for the user based on the vehicle-related data, and transmit information about the available service to a notification device usable by the user.

2. The information processing device according to claim 1, wherein the processor is configured to transmit, to the notification device, information about the vehicle-related data required to be provided to the manager in order for the user to receive the service determined.

3. The information processing device according to claim 1, wherein the processor is configured to determine the available service based on a type and an amount of the vehicle-related data.

4. The information processing device according to claim 1, wherein the processor is configured to determine the available service based on a map defining relationship between the vehicle-related data and the available service and on the vehicle-related data.

5. The information processing device according to claim 1, wherein the processor is configured to
determine a value of the vehicle-related data based on the vehicle-related data, and
transmit, to the notification device, information about the determined value of the vehicle-related data and information about the service available for the user of the vehicle in accordance with the value.

6. The information processing device according to claim 1, wherein the processor is configured to
provide the vehicle-related data to a provider of the service in response to a request from the provider, and
determine the available service such that at least one of an amount and a type of the available service determined based on the vehicle-related data is larger as request frequency that is the number of provision requests from the provider is higher.

7. The information processing device according to claim 1, wherein the processor is configured to determine the available service such that at least one of an amount and the number of types of the available service determined based on the vehicle-related data is larger as freshness of the vehicle-related data is higher.

8. An information processing method executed by a processor, comprising:
determining, when a user of a vehicle provides vehicle-related data that is data related to the vehicle to a manager of the processor, an available service that is a service available for the user based on the vehicle-related data; and
transmitting information about the available service to a notification device usable by the user.

9. A non-transitory storage medium storing a program for causing a processor to execute a process of determining, when a user of a vehicle provides vehicle-related data that is data related to the vehicle to a manager of the processor, an available service that is a service available for the user based on the vehicle-related data, and transmitting information about the available service to a notification device usable by the user.
